(19) United States
(12) Patent Application Publication
(10) Pub. No.: US 2008/0160960 A1
(43) Pub. Date: Jul. 3, 2008

(54) Remote processing device management

(75) Inventors: Paul Michel ElRif, Kirkland, WA (US); Serguei N. Endrikhovski, Bellevue, WA (US); Neal R. Christiansen, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/645,919

(22) Filed: Dec. 27, 2006

(51) Int. Cl. H04M 1/66; H04M 3/00

(52) U.S. Cl. 455/411; 455/412.1

(57) ABSTRACT

In various embodiments, a first processing device may detect an occurrence of an event associated with an alert message. The alert message may include at least one selectable item and may be generated by the first processing device and transmitted to a second processing device. The second processing device may receive the alert message and may present the alert message including the at least one selectable action. A user of the second processing device may select one of the at least one selectable action and a message including an indication of the selected one of the at least one selectable message may be sent to the first processing device. The first processing device may receive the message and may execute a set of instructions corresponding to an alert action represented by the selected one of the at least one selectable message.

### BACKGROUND

Information technology (IT) administrators can receive alert messages on portable devices with respect to high-priority issues concerning a processing device, such as, for example, a server. The portable devices may be, for example, cellular telephones or smart phones. IT administrators also can receive alert messages via e-mail or other means for other matters, such as, for example, server issues or service issues.

After receiving an alert message, the IT administrator can access the processing device via a direct connection by being physically present at the processing device. Alternatively, the IT administrator may access the processing device remotely by using terminal services or other means via a network. For example, the IT administrator may use a cell phone, with a small screen to access a processing device. However, management of the processing device via a small screen may be awkward and difficult. Further, the processing device may be protected from other processing devices and may be remotely accessible only via a highly secure network. Consequently, remote access to the processing device may be difficult.

When the IT administrator accesses the processing device, the IT administrator typically logs onto the processing device and, after successfully logging on, may obtain access to the entire processing device. At this point, the IT administrator may perform a number of processes and may issue various commands with little or no security limitations. Further, the IT administrator may need to perform a number of steps, involving multiple processes, before being able to address issues of which the IT administrator became aware via the alerts.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, an IT administrator, or other user, may place a set of instructions on a first processing device, such as, for example, a server or other processing device. The set of instructions may include instructions in a script language such as, for example, Visual Basic (VB) script, PowerShell, or other scripting language. In some embodiments, the set of instructions may include programming language instructions in a programming language, such as, for example, PERL, C#, or other programming language. The set of instructions may be enabled or activated, such that when a command or a message from a remote processing device is received, the first processing device may execute the set of instructions. The set of instructions may be associated with an alert action represented by an enumerated item or an icon to be included in an alert message. An alert message may be defined such that the alert is generated and sent from the first processing device to the remote processing device when the first processing device detects an occurrence of one or more events. The generated alert message may be context-sensitive based on a context in which the alert message is generated.

When the first processing device detects an occurrence of an event, the first processing device may generate the alert message and may transmit the alert message to the remote processing device. When the remote processing device receives the alert message, the alert message may be displayed on a display screen of the remote processing device. The alert message may include one or more selectable enumerated items or one or more selectable icons representing an alert action to be taken by the first processing device. The user may select one of the one or more enumerated items or the one or more icons and the remote processing device may then transmit a message including an indication of the selected one of the one or more enumerated items or the one or more icons to the first processing device. The first processing device may receive the message, including the indication of the selected one of the one or more enumerated items or the one or more icons, from the remote processing device. The first processing device may then execute the set of instructions associated with an alert action represented by the selected enumerated item or the selected icon.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment consistent with the subject matter of this disclosure.

FIG. 2 is a functional block diagram illustrating an exemplary processing device, which may be used in implementations consistent with the subject matter of this disclosure.

FIGS. 3 and 4 are flowcharts illustrating exemplary processing that may be performed in embodiments of a processing device, such as a server or other processing device.

FIG. 5 is a flowchart that illustrates exemplary processing that may be performed in an embodiment of a remote processing device, such as a remote mobile processing device, or other processing device.

FIGS. 6 and 7 illustrate exemplary displays of an exemplary mobile processing device consistent with the subject matter of this disclosure.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Operating Environment

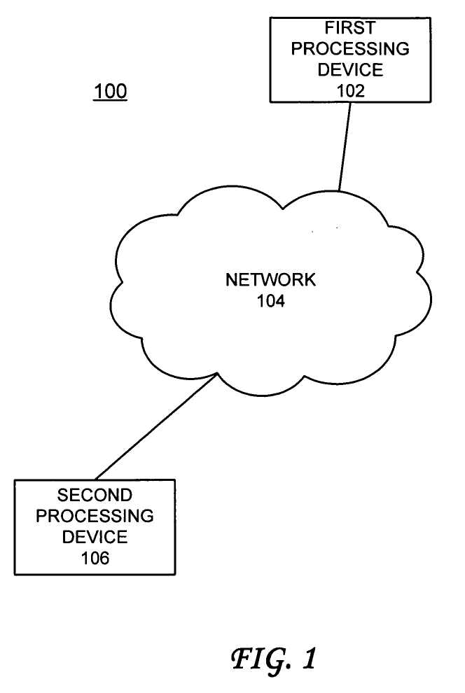

FIG. 1 illustrates an exemplary operating environment 100 for an embodiment consistent with the subject matter of this disclosure. Operating environment 100 may include a first processing device 102, a network 104 and a second processing device 106.

First processing device 102 may be, for example, a server or other processing device. Second processing device 106 may be a portable processing device, including but not limited to, a handheld processing device, a mobile telephone, a portable computer or other processing device capable of executing applications and communicating with first processing device 102 via network 104.

Network 104 may be a wired or wireless network and may include a number of devices connected via wired or wireless means. Network 104 may include only one network or a number of different networks, some of which may be networks of different types. Network 104 may include a packet-switching network, a wireless network, an ATM network, a Frame Relay network, an optical network, a Public Switched Telephone Network (PSTN), a satellite network, the Internet, or an intranet or other types of networks, or any combination of the above networks. In one embodiment, network 104 may be a highly secure network.

FIG. 1 illustrates an exemplary operating environment. Other operating environments or variations of operating environment 100 may be used with other embodiments consistent with the subject matter of this disclosure. For example, in one embodiment, functions or services performed by first processing device 102 may be distributed across multiple processing devices, which may be connected via a network, such as, for example, network 104.

### Exemplary Processing Device

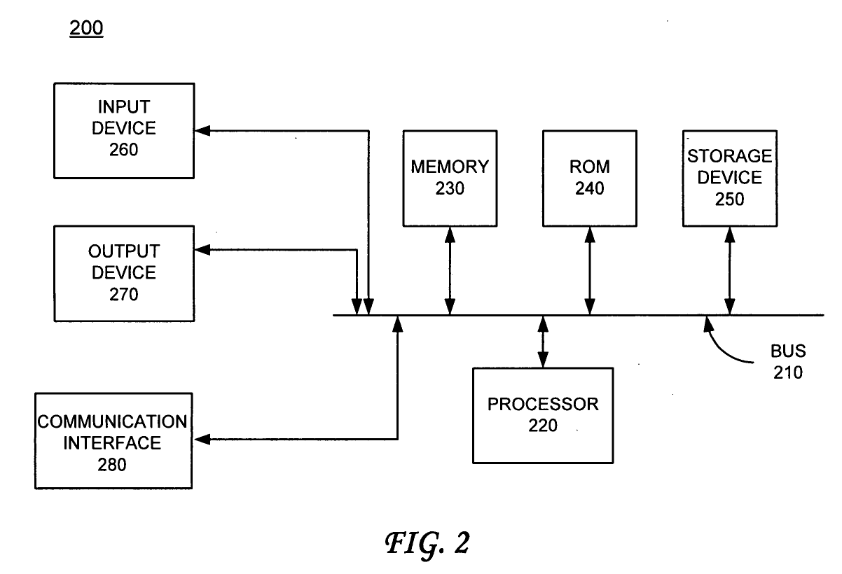

FIG. 2 is a functional block diagram that illustrates an exemplary processing device 200, which may be used to implement first processing device 102 or second processing device 106. Processing device 200 may include a bus 210, a processor 220, a memory 230, a read only memory (ROM) 240, a storage device 250, an input device 260, an output device 270, and a communication interface 280. Bus 210 may permit communication among components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media for storing data and/or instructions.

Input device 260 may include one or more conventional mechanisms that permit a user to input information to processing device 200, such as, for example, a keyboard, a mouse, a keypad, a microphone, or other input device. Output device 270 may include one or more conventional mechanisms that output information to the user, including a display, a printer, a speaker or other transducer, or other output device. Communication interface 280 may include any transceiver-like mechanism that enables processing device 200 to communicate with other devices or networks. In one embodiment, communication interface 280 may include an interface to network 104. The interface may be a wired or wireless interface.

Processing device 200 may perform such functions in response to processor 220 executing sequences of instructions contained in a tangible machine-readable medium, such as, for example, memory 230, ROM 240, or other medium. Such instructions may be read into memory 230 from another machine-readable medium, such as storage device 250, or from a separate device via communication interface 280.

### Overview

An IT administrator of a processing device, such as, for example, a server or other processing device, may be made aware of events that occur on the processing device, such that the IT administrator may respond to an event in a timely fashion by issuing one or more commands to the processing device in response to the occurrence of the event. In existing systems, the IT administrator may access the processing device directly or via a remote terminal service. Direct access to the processing device would require the IT administrator to be physically present at the location of the processing device. Access via a terminal service or other remote access method may require the IT administrator to log onto the processing device and may provide the IT administrator with full access to the processing device. Providing remote full access to the processing device may present a security risk because a hacker may find a way to gain full access to the processing device. Further, the IT administrator may need to perform several steps before being able to enter an appropriate response to a received alert message, thus extending a length of time from a point at which the IT administrator becomes aware of the alert message to a point at which the IT administrator issues a response causing a particular alert action to be executed responsive to the alert.

Embodiments consistent with subject matter of this disclosure may provide a facility for placing a set of instructions on a processing device, such as, for example, a server or other processing device, enabling the set of instructions for remote usage, associating the set of instructions with one or more alert actions, and defining an alert message to be generated upon detection of one or more events. When the processing device detects occurrence of the one or more events, the processing device may generate and transmit an alert message, associated with the one or more of events, to a remote processing device, such as, for example, a mobile or other remote processing device. Examples of the remote processing device may include, but not be limited to, a notebook computer, a personal computer, a cell phone, a smart phone, a personal digital assistant, a dedicated remote management device, or other processing device.

A user of the remote processing device may receive the alert message and may be presented with a menu of alert actions. Upon selection of one of the alert actions, a message may be sent to the processing device. When the message is received by the processing device, the processing device may execute the set of instructions which may correspond to the selected one of the alert actions.

### Exemplary Processing

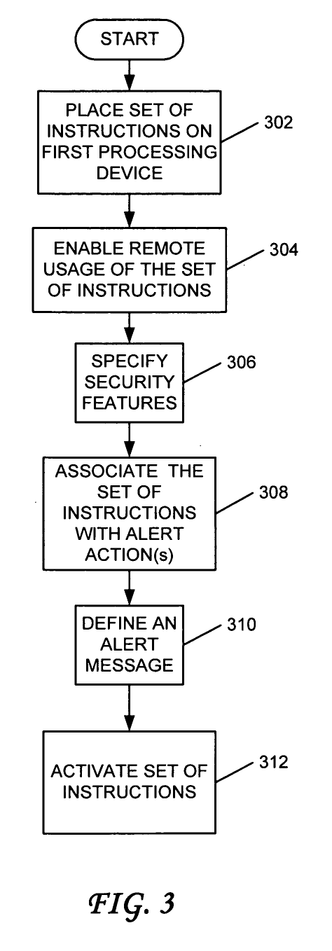

FIG. 3 illustrates an exemplary process for preparing a processing device, such as, for example, first processing device 102, for generating and transmitting an alert message to a remote processing device, such as, for example, second processing device 106. The process may begin by placing a set of instructions on first processing device 102 (act 302). The set of instructions may include instructions in a scripting language such as, for example, Visual Basic (VB) script, PowerShell, or other scripting language. In some embodiments, the set of instructions may include programming language instructions in a programming language, such as, for example, PERL, C#, or other programming language.

Next, the set of instructions may be enabled for remote usage (act 304). This may be achieved by selecting a checkbox on a menu, by entering a command line to first processing device 102, by writing a script, including the set of instructions, that waits for a command before executing the set of instructions, by executing a batch file that executes a script or has a command line for enabling the set of instructions, by implementing a security policy, or by other means. Thus, second processing device 106 may cause the set of instructions to be executed on first processing device 102.

Use of security features to protect from unauthorized execution of the set of instructions may be enabled on first processing device 102 in some embodiments consistent with the subject matter of this disclosure (act 306). For example, in one embodiment, first processing device 102 may authenticate a user of second processing device 106 by requesting the user to enter an authorized user ID and password before permitting the user to cause the set of instructions placed on first processing device 102 to be executed. In another embodiment, second processing device 106 may include a mobile phone, such as, for example, a cell phone, or a smart phone. When the mobile phone sends a message to first processing device 102, in response to receiving an alert message, the sent message may include information related to the mobile phone, such as, for example, caller ID information, or other information. In this embodiment, processing device 102 may permit the mobile phone to cause the set of instructions to be executed only when the received information related to the mobile phone matches any one item of mobile phone information from an authorized list of mobile phone information. In yet another embodiment consistent with the subject matter of this disclosure, in which second processing device 106 may include a mobile phone, a security feature may include a callback feature. In such an embodiment, the mobile phone may receive an alert message from processing device 102. When a user of the mobile phone opens or views the received alert message, a message may be transmitted to first processing device 102 from the mobile phone. First processing device 102 may then receive the message, may disconnect a connection between processing device 102 and the mobile phone, and may callback the mobile phone. The mobile phone may then transmit a message including an indication of an alert action selected by the user. At this point, first processing device 102 may execute the set of instructions indicated by the selected alert action upon receipt of the transmitted message from the mobile phone. In other embodiments, other security features may be available.

Next, the set of instructions may be associated with one or more of alert actions, which later may be represented on a display screen of second processing device 106 when second processing device 106 receives an alert message (act 308). A user may select one icon from a number of icons to represent an alert action. The icon may be included in an alert message sent to second processing device 106 when first processing device 102 detects an event associated with the alert. In some embodiments, the alert message sent to second processing device 106 may pass through one or more other processing devices before being received by second processing device 106.

First processing device 102 may then permit a user to define an alert message to be generated when an occurrence of one or more events is detected on processing device 102 (act 310). An example of an event whose occurrence may cause generation and transmission of an alert message may include, but not be limited to, an unexpected termination of a service, such as, for example, a Server Message Block (SMB) service, or other service. The definition of the alert message may include one or more alert actions which may be requested in response to receiving the alert message.

Finally, first processing device 102 may enable activation of the set of instructions (act 312). Activation of the set of instructions may cause the set of instructions to be available for execution. In some embodiments consistent with the subject matter of this disclosure, multiple sets of instructions may be placed on first processing device 102 and the sets of instructions may be selectively enabled or disabled.

The process illustrated by FIG. 3 is an exemplary process. In other embodiments, other acts, or acts in a different order, may be implemented in first processing device 102 to prepare first processing device 102 for generating and transmitting an alert message to second processing device 106. For example, in another embodiment, an alert action may not be represented by an icon in an alert message. Instead, the alert action may be represented by an item on a menu included in the alert message, such that second processing device 106 receiving the alert message may display the menu on a display screen. The displayed menu may include one or more enumerated items corresponding to a respective alert action.

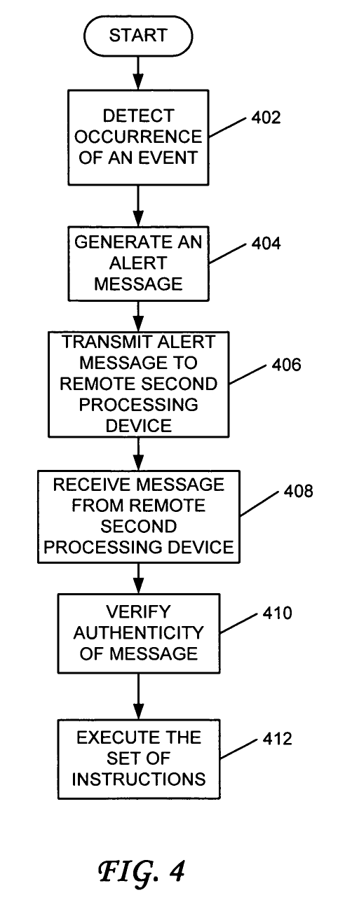

FIG. 4 is a flowchart illustrating an exemplary process that may be performed on first processing device 102 after placing a set of instructions on first processing device 102 and defining an alert message. The process may begin with first processing device 102 detecting an occurrence of an event (act 402). The event may be, for example, a failure of a service, such as a SMB service, another service, or other event. After detecting the occurrence of the event, first processing device 102 may generate an alert message, which is defined to be generated when the event is detected (act 404). The alert message may include a menu having at least one item, which may be selected. Each of the at least one item may represent a corresponding alert action. In an alternate embodiment, the alert message may include one or more icons, which may be selected. Each of the one or more icons may represent a corresponding alert action. First processing device may then transmit the alert message to remote second processing device 106 (act 406). In embodiments consistent with the subject matter of this disclosure, the alert message may be an e-mail, an instant message, a voice message, or other form of communication.

Remote second processing device 106 may receive the alert message and, responsive to receiving the alert message, the remote processing device may transmit a message to first processing device 102. First processing device 102 may receive the message from remote second processing device 106 (act 408) and may verify authenticity of the message by authenticating a user of remote second processing device 106 or remote second processing device 106, itself (act 410). As previously mentioned, in an embodiment, first processing device 102 may request a user of remote second processing device 106 to enter a user ID and password, which first processing device 102 may verify against a list of authorized user IDs and passwords. In another embodiment, remote second processing device 106 may include a mobile phone, such as, for example, a cell phone or a smart phone. When the mobile phone initiates a connection to first processing device 102, such as, for example, when the mobile phone responds to a received alert message, the mobile phone may place a call to first processing device 102 causing caller ID information or other information related to the mobile phone to be received by first processing device 102. First processing device 102 may then compare the caller ID information or the other information related to the mobile phone against a list of authorized caller ID information or authorized information related to mobile phone, such that if the received information matches an item on the list, second processing device 106 may be authenticated. In another embodiment, first processing device 102 may receive a message from second processing device 106, which may include a mobile phone, in response to sending an alert message to the mobile phone. First processing device 102 may terminate a connection with the mobile phone and may initiate a callback to the mobile phone. The mobile phone may then transmit a message, including a selection from a displayed menu of items representing one or more alert actions, to first processing device 102. In other embodiments, other security features may be implemented.

Upon receiving, from second processing device 106, a message including a selected item from the displayed menu of items representing the one or more alert actions, first processing device 102 may execute a set of instructions corresponding to the selected item (act 412).

The process illustrated in FIG. 4 is an exemplary process. In other embodiments consistent with the subject matter of this disclosure, different or other acts may be performed, and/or the acts may be performed in a different order.

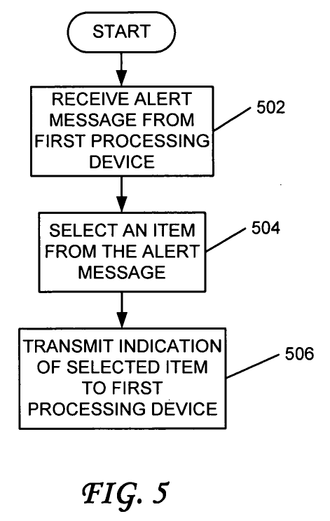

FIG. 5 illustrates a flowchart for an exemplary process that may be performed by second processing device 106, which may receive an alert message from first processing device 102. The process may begin with second processing device 106 receiving an alert message from first processing device 102 after first processing device 102 detects an occurrence of an event, such as, for example, failure of a service or other event (act 502). The alert message may include a menu having one or more enumerated items, or one or more icons, each of the items or icons representing an alert action. Further, the menu of items or the icons included in the alert message may depend on the particular alert message generated. In other words, the particular menu of items or the icons included in the alert message may be context-sensitive, based on a context in which the alert message is generated.

A user of second processing 106 device may select one of the enumerated items or icons (act 504). Second processing device 106 may then transmit an indication of the selected item or icon to first processing device 102, which may execute a set of instructions associated with an alert action corresponding to the selected item or icon (act 506).

The flowchart of FIG. 5 illustrates an exemplary process that may be executed on second processing device 106, which may be a personal computer, a notebook computer, a cell phone, a smart phone, a personal digital assistant (PDA) or other processing device. In other embodiments, other acts may be performed, or an order of the acts may be different. Further, in some embodiments, first processing device 102 may request a user of second processing device 106 to enter a user ID and password to authenticate the user before the selected action may be performed by processing device 102. In other embodiments, second processing device 106 may include a mobile phone, such as, for example, a cell phone or a smart phone, and when the mobile phone responds to a received alert, processing device 102 may receive caller ID information or other information related to the mobile phone, which may be checked against a list of authorized information related to the mobile phone in order to authenticate the user of the mobile phone or the mobile phone, itself.

### Exemplary Alert Message

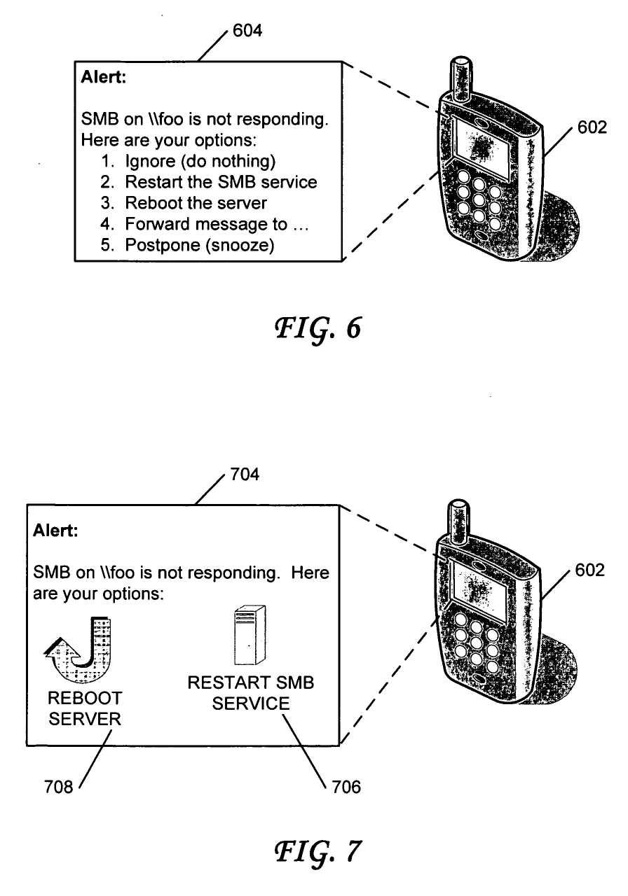

FIG. 6 illustrates an exemplary mobile processing device 602 displaying an exemplary alert message on a display screen 604 in an embodiment consistent with the subject matter of this disclosure. The exemplary alert message may include information regarding an event detected on first processing device 102. In this example, the event indicates a non-responsive SMB service on first processing device 102. Display screen 604 may display a number of items representing alert actions, one of the items may be selected by a user of mobile processing device 602. The user may select one of the items by pressing a key corresponding to the desired item, pressing a hard or soft key associated with the desired item, by using one or more navigation keys to select the desired item, or by other selection methods. In one embodiment, the display screen of mobile processing device 602 may be a touch screen. In such an embodiment, the user may select a desired item by touching a portion of the display screen over an area of the display screen that displays the desired item. The user may touch the display screen with a stylus, an electronic pen, a finger, or other object.

FIG. 7 illustrates an exemplary mobile processing device 602 displaying an exemplary alert message on a display screen 704 in an embodiment consistent with the subject matter of this disclosure. The exemplary alert message may include information related to an event detected on first processing device 102. As in the example of FIG. 6, the exemplary event indicates a non-responsive SMB service on processing device 102. Display screen 704 may display one or more items, such as, for example, icons, which may be associated with a corresponding alert action. In this example, display screen 704 displays two icons, icon 708 indicating a desire to reboot a server, and icon 706 indicating a desire to restart the SMB service. The user may select one of the icons by pressing a hard key, a soft key of mobile processing device 602 associated with the one of the icons, or via other selection methods. In other embodiments, mobile device 602 may include a touch screen and the user may select one of the icons by touching an area of the touch screen over an area of the display screen that displays a desired one of the icons. The user may select the desired icon by touching the touch screen with a stylus, an electronic pen, a user's finger, or other object.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

1. A method for remote management of a first processing device, the method comprising:
detecting and occurrence of an event on the first processing device;
generating an alert message in response to the detecting of the occurrence of the event, the alert message including at least one selectable item corresponding to an alert action, the alert message being context-sensitive based on a context in which the alert message is generated;
transmitting the alert message to a second processing device;
receiving, responsive to the transmitting of the alert, a message from the second processing device including an indication of a selected one of the at least one selectable item selected by a user of the second processing device; and
executing, on the first processing device, a predefined set of instructions associated with an alert action represented by the selected one of the at least one selectable item in response to the receiving of the message from the second processing device.

2. The method of claim 1, further comprising:
receiving a connection from the second processing device;
breaking the connection with the second processing device; and
reestablishing the connection to the second processing device from the first processing device, wherein
the receiving of the connection from the second processing device, the breaking of the connection with the second processing device, and the reestablishing of the connection to the second processing device occur before the receiving of the message from the second processing device including the indication of the selected one of the at least one selectable action.

3. The method of claim 1, wherein the second processing device includes a cell phone or a smart phone.

4. The method of claim 1, further comprising:
authenticating the second processing device.

5. The method of claim 1, wherein the second processing device is a cell phone or a smart phone, the method further comprising:
authenticating the cell phone or the smart phone based, at least in part, on caller ID information.

6. The method of claim 1, further comprising:
authenticating the second processing device based, at least in part, on a password received from the second processing device.

7. The method of claim 1, wherein the alert message includes an enumerated menu having the at least one selectable item for selection by the user of the second processing device.

8. A method for preparing a first processing device for remote management, the method comprising:
placing a set of instructions on the first processing device, the set of instructions to be executed by the first processing device upon receiving a message including an indication of a selected one of at least one selectable item from a second processing device; and
defining an alert message to be generated and sent to the second processing device upon detecting an occurrence of an event on the first processing device, the alert message including the at least one selectable item to be presented at the second processing device, one of the at least one selectable item corresponding to an alert action associated with the corresponding set of instructions placed on the first processing device.

9. The method of claim 8, further comprising:
specifying that the first processing device is to authenticate the second processing device or a user of the second processing device before the first processing device will execute the set of instructions in response to receiving the message from the second processing device.

10. The method of claim 8, wherein the second processing device includes a cell phone or a smart phone, the method further comprising:
specifying that the first processing device is to call back the cell phone or the smart phone when the cell phone or the smart phone initiates a call to the first processing device.

11. The method of claim 8, further comprising:
specifying that the first processing device is to authenticate the second processing device or a user of the second processing device before the first processing device will execute the set of instructions in response to receiving the message from the second processing device, wherein
the first processing device authenticates the second processing device when a valid password is received from the second processing device.

12. The method of claim 8, further comprising:
specifying that the first processing device to is authenticate the second processing device or a user of the second processing device before the first processing device will execute the set of instructions in response to receiving the message from the second processing device, wherein
the second processing device includes a cell phone or a smart phone, and
the first processing device authenticates the second processing device when caller ID information identifying a phone number of the cell phone or the smart phone is received by the first processing device.

13. The method of claim 8, further comprising:
associating the set of instructions with an alert action represented by an icon to be presented with the alert message at the second processing device.

14. The method of claim 8, further comprising:
placing a plurality of sets of instructions on the first processing device, a respective one of the plurality of sets of instructions to be executed upon receiving a message including a corresponding indication of a selectable item from the second processing device; and
selectively activating at least one of the plurality of sets of instructions for execution.

15. A processing device comprising:
at least one processor;
a memory including instructions for the at least one processor; and
a bus connecting the at least one processor with the memory, the memory comprising:
instructions for receiving an alert message from a different processing device, the alert message indicating an occurrence of an event at the different processing device and including at least one selectable item representing an alert action to be taken by the different processing device, the received alert message being context-sensitive with respect to a context in which the alert message was generated,
instructions for permitting a user to select one of the at least selectable item from the alert, and
instructions for sending a corresponding message to the different processing device in response to the user selecting the one of the at least one selectable item, the receiving of the corresponding message at the different processing device causing the alert action to be executed by the different processing device.

16. The processing device of claim 15, wherein the memory further comprises:
instructions for sending authenticating information to the different processing device, the different processing device causing execution of the alert action only after reception of valid authenticating information from the processing device.

17. The processing device of claim 15, wherein the memory further comprises:
instructions for sending device identifying information to the different processing device, the different processing device causing execution of the alert action only after reception of authorized device identifying information from the processing device.

18. The processing device of claim 15, wherein
the at least one selectable item includes an icon, the icon to be displayed on a display screen of the processing device, and
selection of the icon by the user causes the corresponding message to be sent to the different processing device.

19. The processing device of claim 15, wherein the instructions for sending a corresponding message to the different processing device in response to the user selecting the one of the at least one selectable item, further comprises:
instructions for making a first connection to the different processing device,
instructions for receiving a second connection from the different processing device in response to the making of the first connection, and
instructions for sending the corresponding message to the different processing device via the second connection.

20. The processing device of claim 15, wherein
the at least one selectable item includes at least one enumerated item, the at least one enumerated item to be displayed on a display screen of the processing device, and
selection of one of the at least one enumerated item by the user causes the corresponding message to be sent to the different processing device.
